(19) United States
(12) Patent Application Publication
(10) Pub. No.: US 2018/0247375 A1
(43) Pub. Date: Aug. 30, 2018

(54) METHOD AND SYSTEM OF FUNDING A BUSINESS ENTITY

(71) Applicant: Milton H. Barbarosh, Highland Beach, FL (US)

(72) Inventor: Milton H. Barbarosh, Highland Beach, FL (US)

(21) Appl. No.: 15/896,482

(22) Filed: Feb. 14, 2018

Related U.S. Application Data
(60) Provisional application No. 62/458,664, filed on Feb. 14, 2017.

(51) Int. Cl. G06Q 40/06

(52) U.S. Cl. CPC G06Q 40/06

(57) ABSTRACT

Provided are a system and method of funding a business entity utilizing a famous or well-known sponsor that allows investors to invest in a business entity at the ground level. Sponsor investment information is transmitted to registered investors. The registered investors can submit capital bids to the system. The accepted bids represent capital investors paid the business entity.

### FIELD OF THE INVENTION

The invention relates to a system and method of funding a business entity utilizing a famous or well-known sponsor that allows investors to invest in a business entity at the ground level.

### BACKGROUND OF THE INVENTION

Funding is difficult for emerging businesses, in particular, but the problem exists for most small and medium sized companies. Raising capital at any stage of a company's growth is challenging and requires creativity and tenacity. However, these hurdles are especially difficult to conquer at the earliest stages of an enterprise's development.

At the seed level, an entrepreneur (also referred to as an owner, partnership, business, or corporation) is looking for capital to acquire the initial resources needed to launch the enterprise, attract and hire employees, conduct research and development, acquire computer systems, and build initial inventory. Although this time in the business is characterized by frustration, struggles, setbacks, and delays, there are many sources of cost-effective seed capital available if one is creative and aggressively searches and still allow the entrepreneur to maintain control and majority ownership of the business.

Typically companies are started with the owner's own resources. The combination of the owner's financial investment and time investment (“sweat equity”) is a prerequisite to obtaining capital from third-party sources today. The capital markets expect the owner to put their own funds at risk before asking others to risk investing in your business. This is often called the “straight-face test” because the owner is able to look an investor in the eye and demonstrate your own commitment and belief in the potential of the new enterprise. If the owner has co-founders, all are expected to make this commitment. This is true even if the level of personal investment varies due to differences in the partners' financial circumstances or the degree to which a particular individual contributes a particular skill, recipe, knowledge, or relationship, which is the intangible, non-financial aspect of contribution.

The initial capital may come from savings, 401(k) plan loans (where permitted) or withdrawals, home-equity loans, credit cards, or other sources as set forth below. Of course, this also violates the OPM (Other People's Money) rule: Wherever possible, use other people's money to invest in a risk enterprise. However, in the world of new-venture financing, the OPM rule usually goes out the window unless one is a veteran entrepreneur with an established track record and can demand that others risk their capital without investing their own funds in the enterprise.

Only the entrepreneur can dictate what portion of one's life savings one is willing to risk, and prudence should dictate some level of conservatism, which may vary depending on the immediate cash needs as well as the short-to-medium-term goals and requirements. An individual with limited savings and two children nearing college age should be very careful with their savings and may want to reconsider whether this is the right time to launch a business venture at all. Conversely, a young couple with toddlers and one working spouse may decide that this is a perfect time to use their savings to launch a business. They know that they have a steady source of income from the working spouse and plenty of time to replenish their savings if the business venture is unsuccessful.

After exhausting that portion of the business owner's life savings and available credit lines to finance the start of the business, the next most likely source of capital usually comes from those who love and trust you—family, friends, and fools. Whether it's an equity investment or a formal or informal loan, entrepreneurs often turn to old friends and family members, who typically provide capital on the basis of a relationship rather than on the basis of financial rewards.

Turning to family for investment raises many problems. The owner would have to be prepared to provide business-plan updates at family dinners and to be reminded weekly of “who helped you get started.” The benefits of this inexpensive capital may be outweighed by the costs of the family dynamics and by the complex emotions of guilt, despair, and frustration if the business fails and the family investment is lost.

Turning to old friends for money may also be unwise, particularly when the friend is investing in your new business based on trust and can't really afford to lose the money if things go south. Business loans and investments have ruined a lot of longstanding relationships. The Catch-22, of course, is that if things go very well, the family and friends wind up arguing with the owner because the owner didn't give them a chance to participate. Again, the owner knows their friends and family and their tolerance for risk, and only the owner can decide whether it will be advisable or appropriate to approach family and friends for seed and early-stage capital.

If one decides to solicit friends and family as a source of capital, they must be very open and honest about the risks and rewards of the enterprise—and the risks are likely to be much more significant than the rewards in the early stages of the business. They must make sure that they know that this is not like investing in the public stock market where public reporting, a track record, and the availability of liquidity protect against downside risk. The owner should also put the terms of the investment arrangements into writing to formalize the transaction and to avoid confusion about the rights and responsibilities of the parties.

Once one has demonstrated that their own funds are at risk and have exhausted their “emotional investors” (family, friends, co-workers, and others who love and trust you), they can quest for an angel. The term “angel” originated on Broadway, where wealthy investors provided funds to aspiring directors to finance the production of a new musical or drama. The motivation for the investment, which included financial reward, was mainly driven by the love for the theater and the chance to develop friendships with aspiring actors, playwrights, and producers. The point was that these investors provided high-risk capital and were motivated by something more than money. Even today, playwrights, artists, producers, and musicians often rely on the altruism of others to advance their projects or careers. Likewise, an aspiring entrepreneur must rely on something other than financial reward as an impetus for the investment. The focus in meeting and presenting to angels must be on what makes this person motivated to invest more than what IRR will be attractive to their wallet.

Beyond Broadway, angel investing has become a critical source of financing for seed and early-stage companies. From Arthur Rock in the early 1960s, whose angel dollars and capital-formation efforts helped launch companies, such as Intel and Apple Computer, to cashed-out entrepreneurs, such as Lotus founder Mitch Kapor, whose angel investments include RealNetworks and UUNet, to new economy multimillionaires and Internet pioneers like Ted Leonsis of America Online, and the early-stage investors in Google, thousands of modern-day angels have played a key role in the launch, development, and financing of scores of early-stage companies, as well as the mentoring and assistance to thousands of entrepreneurs.

Angels come in different shapes and sizes and often invest for different reasons. Some are motivated by something much larger than financial return—a good thing, since it is hard to convince someone with a net worth of $125 million that a deal will make them rich. There are “checkbook angels,” usually friends, neighbors, and others who typically invest $5,000 to $25,000 on a passive basis hoping to get in early on the next Yahoo!. Then there are “capital-A” angels who typically invest $50,000 to $250,000 on a more active basis and who may insist on some advisory or mentoring role as a condition to their commitment. Finally, there are the “super-angels,” the cashed-out multimillionaires and even billionaires who have the capacity and the guts to invest $500,000 to $2 million in an early-stage enterprise in a deal that may look more like a venture-capital transaction from a legal paperwork and control perspective than like an angel deal.

Although the business media tend to focus on the activities of the institutional venture-capital firms, the amount of money invested annually by angels or private investors in growing businesses is greater. Angel investors have become a critical source of seed capital at a time when venture capital funds are leaning towards latter-stage investments.

However, the number of ventures under management remains small because it takes as much time to research and manage a small investment as a large one. Thus, the minimum first-round investment by a venture-capital firm is now about $4 million, eliminating many entrepreneurs and early-stage companies who are looking for investments of as little as $50,000. The enormous success of the venture capital-industry has opened a window of opportunity for angels or private investors looking for start-ups in which to invest.

Angel investing has grown significantly in recent years as baby-boomers near retirement with significant wealth. Angels also include cashed-out entrepreneurs who may have feathered their nests by selling their business or taking it public. Some angels provide capital to entrepreneurs as a type of “quasi-philanthropy,” a way to give something back to their communities in the spirit of fostering local economic growth. Others are savvy private investors who also helping an entrepreneur launch a new business along the way.

It is critical for an entrepreneur seeking angel investment to understand the angel's need and motivations and then take steps to meet these needs. Maybe the entrepreneur is the child these angels never had; maybe the entrepreneur reminds them of themselves when they were younger; or perhaps they just want someone to coach. Maybe they've retired and need to get out of the house and feel useful; maybe they have expertise and relationships that they want to share, or they're just bullish on the industry and looking for a way to participate. It's the entrepreneur's job to discover the reason and structure the relationship accordingly.

While one can find individual angels through referral from an accountant or attorney, angels increasingly participate in a variety of networks. There are more than 50 loose-knit organizations nationwide through which investors learn about opportunities, attend programs about investing, and develop a sense of community. These networks are usually run by nonprofit entities, have tax-exempt status, and are oriented toward economic development. The greatest benefits come from community building among investors and creating a more efficient marketplace for entrepreneurs to approach sources of capital.

A more recent phenomenon involves pools of funds in which investors (anywhere from a handful to dozens) pledge a specific amount of money to be invested in private-equity transactions that are selected and managed by the group. Sometimes the group has centralized paid staff; sometimes it is led and organized by a lead investor. These groups set legally rigorous standards, are focused, and are designed to profit from multiple transactions. In this model, investors place a set amount into a “club” account that is used like a venture fund to make investments found and voted on by club members. This approach can be staffed or unstaffed. More money can be accumulated than an individual can afford, and a more diversified fund can be created. Group dynamics are involved because each member must review potential opportunities in order to decide “vote” for or against a deal.

A small venture fund, usually a limited partnership, can created by investors drawn from a specific business community. They provide assistance as well as capital to chosen companies, which are usually from the same field. Members of the group may take on general partnership responsibilities, or professional managers can be employed. This model is similar to the traditional venture-capital model, except that investments are more focused and the limited partners are more active in helping to find opportunities and to provide hands-on assistance to the companies chosen.

Active angels are more active in the role that they propose to play in the growing company once funds are committed. Some angels in this model are really looking for full or almost full-time employment with the companies in which they invest.

There are online angels having websites that seek to match angels and entrepreneurs as well as provide information and resources for early-stage companies seeking to raise public or private capital. These “e-capitalists” all focus on different niches and services at different fee levels. Typically, the entrepreneurs are asked to fill out forms that outline the history of their business, the market for their product or service, the amount of capital they are seeking, and related background information. The online matchmaker will then screen submissions and post them, or in some cases it will match entrepreneurs with interested angel investors. Some sites offer online chat areas where angels and entrepreneurs can meet to discuss the business plans. Other sites post the business plans, and still others simply encourage the investor to contact the entrepreneur directly. The sites are open only to institutional investors and venture-capital funds.

From a practical perspective, it's just as important for one to perform due diligence and pre-qualify prospective funding sources as for the angel to scrutinize business plans and evaluate management. In addition to the regional or national angel networks mentioned above, there are a number of online resources to direct entrepreneurs to private investors. One should also attend venture and trade fairs and forums. Networking through friends and associates—getting out there and talking to as many people as possible—is still the best way to find an angel. Remember, dancing is, in the end, a person-to-person activity.

One can also find potential angels through networking in business and venture groups, private investor clubs (which usually have organized monthly presentations by entrepreneurs to potential pre-qualified angels), venture-capital networks, incubators, industry trade associations, university and fraternity alumni meetings, social and country clubs, and virtually any other place where semi-retired and cashed-out entrepreneurs may hang out. Angels may invest alone or as a group through clubs and networks (“bands of angels”). Although many won't consider a deal that requires more than $50,000, a growing number of very-high-net-worth individuals (“super-angels”) will invest $500,000 or more of their own money and help you identify other potential investors. These super-angels also bring respect and credibility to a new business because others respect their expertise and industry knowledge.

The angel/investor relationship is akin to a spouse or parent—so one has to be sure that they can get along personally with the individual. Non-financial expectations have to be defined and a meeting of the minds made on these issues. A good angel offers a lot more than money. One needs to reach an agreement regarding how much of the angel's time will be available for advice, coaching, and mentoring as well as what doors the angel is expected to open. Ideally, the angel should have a diverse and current Rolodex, deep industry experience, and significant company-building experience in addition to being a source of seed capital. Indeed, the angel-entrepreneur relationships that don't work out over the years often fail because of misunderstandings about the non-financial aspects of the relationship.

The average entrepreneur does not have easy access to investment capital. Furthermore, government regulations set a high hurdle for the average entrepreneur to raise capital. There is a great need for a simplified approach for the average entrepreneur to raise capital.

### SUMMARY OF THE INVENTION

An objective of the invention is provide a new funding approach that ensures government compliance. A further objective is to utilize funds from anyone, such as non-accredited investors, so that any investors can invest at the ground level and to also greatly increase the amount of funds available to businesses.

The present invention can provide an entrepreneur with a sponsor, such as major companies, media stars, or media outlets (such as Shark Tank), or other type of well-known entity, to allow ordinary investors to co-invest, on the same basis, with a professional investor or accredited investor.

The individual investor does not presently have access to the caliber of co-investment opportunities, nor can they invest on the same terms and conditions as the professional investors. Using the designed methodology below the common investor can now have the ability to invest along with, for example, Starbucks, as it finds an investment it wants to make. Starbucks could offer the general public the right to invest on the same terms and conditions as its investment. This could be done by modifying Starbucks current mobile app, or through a captive email list that it has or creates.

Companies such as General Motors, Starbucks, Google, Amazon, Microsoft, and most celebrities such as Britney Spears (over 40 million Facebook and Twitter followers), have extensive databases they can easily access to offer this sharing of the right to invest in the same opportunities they are investing in, and they are constantly making investments as they grow their own businesses. These companies or celebrities are “Sponsors”.

Transparency—as it shows the general public what investments the Sponsors are making.

Good marketing—as it builds a new form of loyalty to those who invest to tie them closer to the Sponsors.

Huge impact on the future of our country—with startups, emerging businesses and growth companies having easier access to capital will increase activity and spur the economy;

Increased access to capital—means increased employment as businesses grow;

Ability for America to once again be a leader in technology and innovation;

Fairness to the general public—who can only invest in a business entity once it is public, while the professional investors exit or make a fortune on the initial public offering.

Small Investors do not have access to Sponsored deals which make their investments much riskier.

The secret to crowdfunding is having a crowd. Major companies, celebrities and media outlets have a crowd which is easily accessible. For example Starbucks has over 12 million users of its mobile app. Presently, these users are offering the ability to receive or purchase “apps” or songs. Now these users are allowed to co-invest with Starbucks, on the same terms and conditions, into a new business entity that Starbucks is going to invest in. If this was offered to the 12 million users and they were told it was first come first served, and they could invest $500 as a minimum, and a total investment of $5.0 million and Starbucks was putting in $5.0 million, the new or emerging business would raise $10 million in a very short period of time. Similarly, the TV Show Shark Tank could exploit the present invention by offering investors the ability to co-invest with the Sharks once they make a decision on a deal, and a ticker tape would run at the bottom of the TV screen showing how much is still available to invest with the Shark(s).

The above objects and other objects can be obtained by a method of providing funding to a business entity comprising:
providing a platform connected to a network, the platform comprising a processor, non-transitory memory, a database stored in the memory, investor information stored in the database comprising name of investor, contact information of the investor, and whether the investor is a registered investor, sponsor information stored in the database comprising identification of sponsor, and the platform being programmed to connect to a plurality of user interface devices;
inputting investment information to a platform, the investment information comprising an identity of a business entity and a capital investment made from the sponsor to a business entity;
transmitting the investment information from the platform to the plurality of user interface devices, the user interface devices comprising a display;
displaying on the display a display screen comprising the investment information;
inputting, by registered investors, investor capital investments to the business entity on the plurality of user interface devices;
transmitting, by the user interface device, the investor capital investments to the server;
accepting or denying, by the platform, the investor capital investments based on whether an investment limit has been reached.

The objectives of the invention can also be obtained by a system constructed to practice the method, and also by a display screen for a user interface device having a display, the display screen comprising:
a name or logo identifying a business entity in need of capital;
a name or logo identifying a sponsor providing capital investment to the business entity;
a sponsor indicator statically identifying an amount of capital investment a sponsor transferred to the business entity;
a user graphical indicator dynamically identifying an investment limit for accepting a investor capital investment; and
an investor capital investment input.

### BRIEF DESCRIPTION OF THE DRAWINGS

FIG. 1 illustrates an exemplary funding system and method.

FIG. 2A illustrates an exemplary flow chart of a funding system and method.

FIG. 2B illustrates an exemplary flow chart of a funding system and method in which a potential investor can become a registered investor.

FIG. 2C illustrates an exemplary flow chart of a funding system and method of the funding provided by a registered investor.

FIG. 2D illustrates an exemplary flow chart of a funding system and method of sponsor investment information.

FIGS. 2E-2F illustrate exemplary funding systems and methods.

FIG. 3 illustrates an example of how the funding method can work with an actual portal.

FIG. 4 illustrates an exemplary investor screen.

FIG. 5 illustrates a funding method and system.

FIG. 6 illustrates and exemplary Display Screen.

### DETAILED DESCRIPTION OF THE INVENTIONS

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention. However, it will be apparent to one skilled in the art that the present invention may be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention.

The invention will now be explained with reference to the attached non-limiting Figs. The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

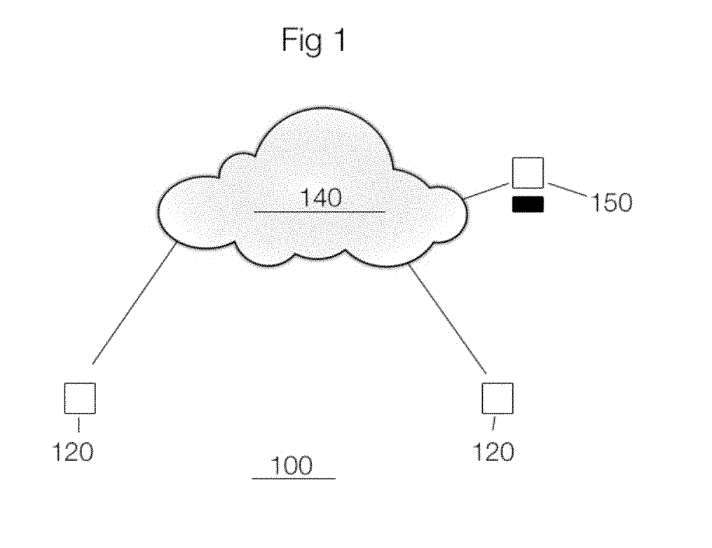

FIG. 1 describes an example of a business funding system 100. The business funding system 100 comprises a platform (main server) 150 and a plurality of user interface device 120. The user interface devices 120 and the platform 150 are connected via a communication network 140. All connections between the user interface devices 120 and platform 150 can be direct, indirect, wireless and/or wired as desired.

Various networks 140 may be implemented in accordance with embodiments of the invention, including a wired or wireless local area network (LAN) and a wide area network (WAN), wireless personal area network (PAN) and other types of networks that comprise or are connected to the Internet. When used in a LAN networking environment, computers may be connected to the LAN through a network interface or adapter. When used in a WAN networking environment, computers typically include a modem, router, switch, or other communication mechanism. Modems may be internal or external, and may be connected to the system bus via the user-input interface, or other appropriate mechanism. Computers may be connected over the Internet, an Intranet, Extranet, Ethernet, or any other system that provides communications, such as by the network 140. Some suitable communications protocols may include TCP/IP, UDP, OSI, Ethernet, WAP, IEEE 802.11, Bluetooth, Zigbee, IrDa, WebRTC, or any other desired protocol. Furthermore, components of the system may communicate through a combination of wired or wireless paths, including the telephone networks.

The business system 100 can be accessed via any user interface device 120 that is capable of connecting to the platform 150. An exemplary user interface device 120 contains a web browser and display. This includes user interface devices 120 such as internet connected televisions and projectors, tablets, iPads, Mac OS computers, Windows computers, e-readers, and mobile user devices such as the smartphones, iPhone, Android, and Windows Phone, and other communication devices. Preferably, the user interface device 120 is a television, tablet or smartphone. The smartphone can be in any form, such as a hand held device, wristband, or part of another device, such as vehicle. The user interface devices 120 can connect to the platform 150 via the internet and/or wirelessly, such as through a mobile telephone network 140, and/or any other suitable medium. The user interface device 120 preferably includes an I/O interface that allows a user to interact with the business system 100. The I/O interface may include any hardware, software, or combination of hardware and software.

The business system preferably has a connection capacity so that at least 100 user interface devices 120 can be simultaneously connected to and in communication with the platform 150. Preferably the connection capacity is at least 500, more preferably at least 1,000, more preferably at least 5,000, more preferably at least 10,000, and most preferably at least 20,000 user interface devices 120 can be simultaneously connected to and in communication with the platform 150.

The computer processing unit (CPU) of the user interface device 120 can be implemented as a conventional microprocessor, application specific integrated circuit (ASIC), digital signal processor (DSP), programmable gate array (PGA), or the like. The CPU executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The memory may include random access memory (RAM), ready-only memory (ROM), programmable memory, flash memory, and the like. The memory, include application programs, OS, application data etc. The exemplary user interface device 120 preferably also includes a network module connected to an antenna to communicate with rest of the business system 100.

The platform 150 described herein can include one or more computer systems directly connected to one another and/or connected over the network 140. Each computer system includes a processor 152, non-volatile, non-transitory memory 154, user input and user output mechanisms, a network interface, a database 156 and executable program code (software) 158 comprising computer executable instructions stored in non-transitory tangible memory that executes to control the operation of the platform 150. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The platform 150 can run any desired operating system, such as Windows, Mac OS X, Solaris or any other server based operating systems. Other embodiments can include different functional components. In addition, the present invention is not limited to a particular environment or platform 150 configuration. Preferably, the platform 150 is a cloud based computer system. If desired for the particular application, the platform 150 or portions of the platform 150 can be incorporated within one or more of the other devices of the business system 100, including but not limited to a user interface device 120.

The platform 150 includes at least one web server and the query processing unit. The web server receives the user query and sends it to the query processing unit. The query processing unit processes the user query and responds back to the user interface device 120 via the web server. The query processing unit fetches data from the database server if additional information is needed for processing the user query. The database 156 can be stored in the non-volatile, non-transitory memory. The term “database” includes a single database and a plurality of separate databases. The platform 150 can comprise the non-volatile, non-transitory memory or the platform 150 can be in communication with the non-volatile, non-transitory memory storing the database. The database 156 can be stored at different locations.

Software program modules 158 and database 156 stored in the non-volatile memory the platform 150 can be arranged in logical collections of related information on a plurality of computer systems having associated non-volatile memories. The software 158 and database 156 can be stored using any data structures known in the art including files, arrays, linked lists, relational database tables and the like. The platform 150 is programed to perform the processes described herein.

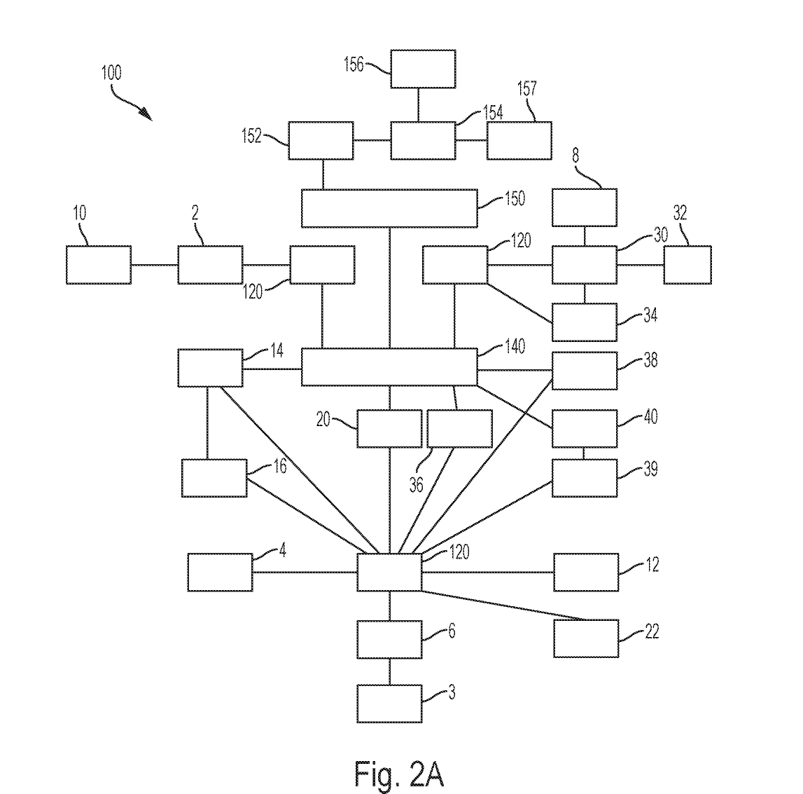

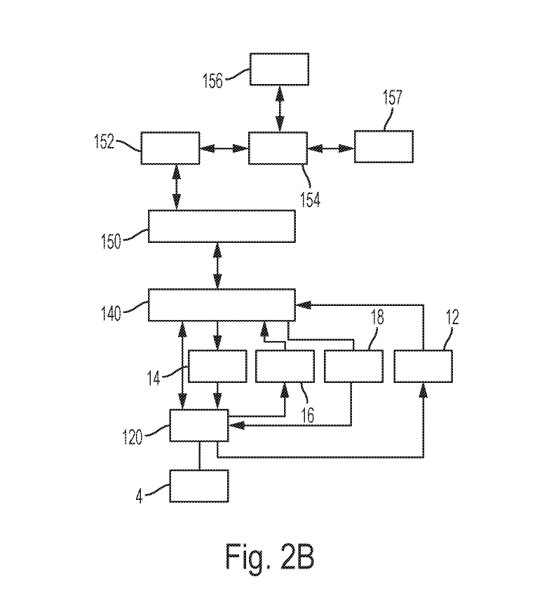

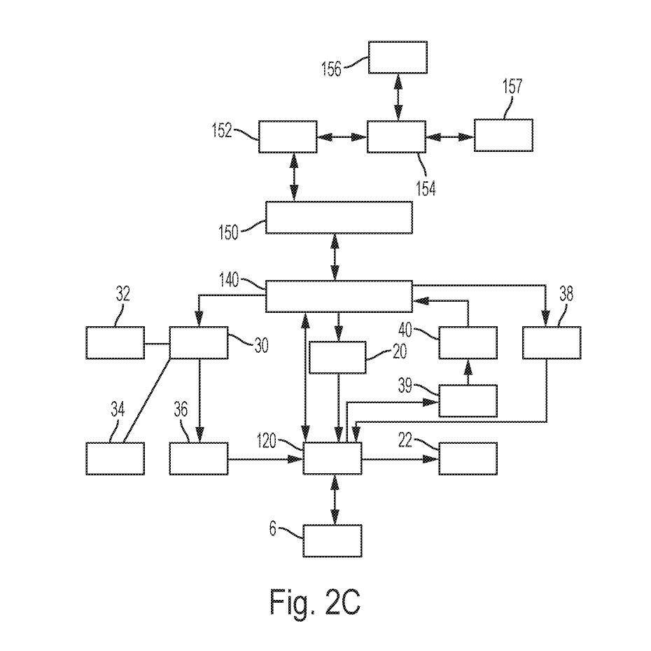

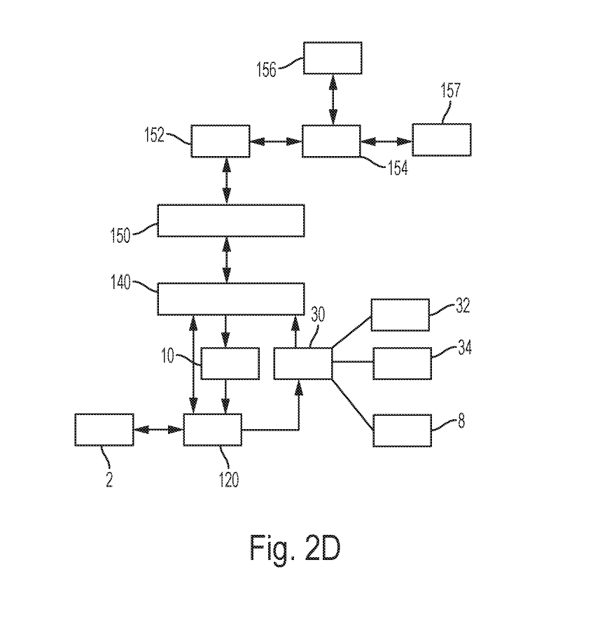

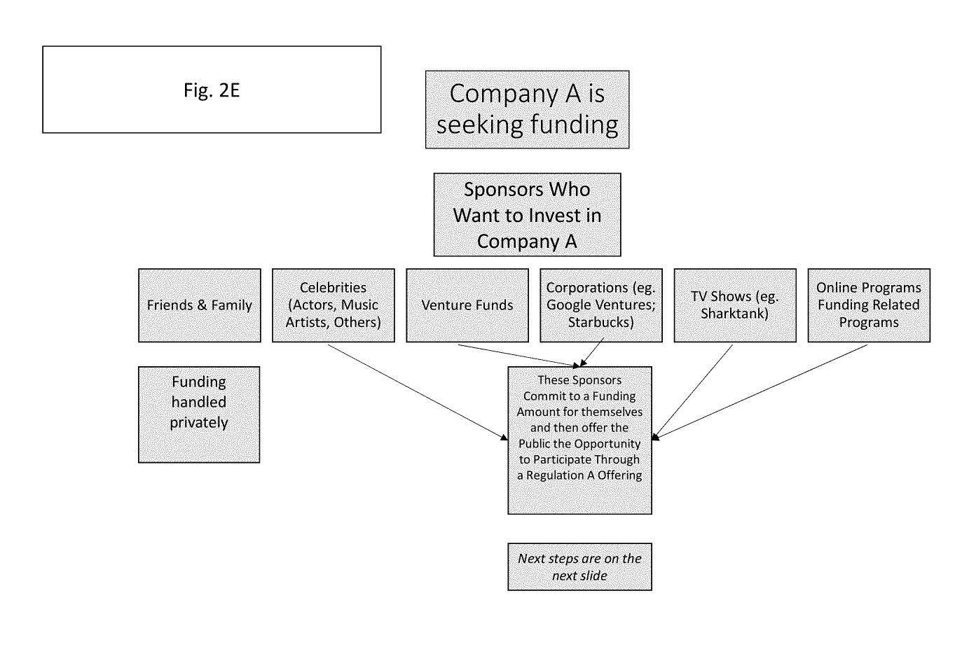

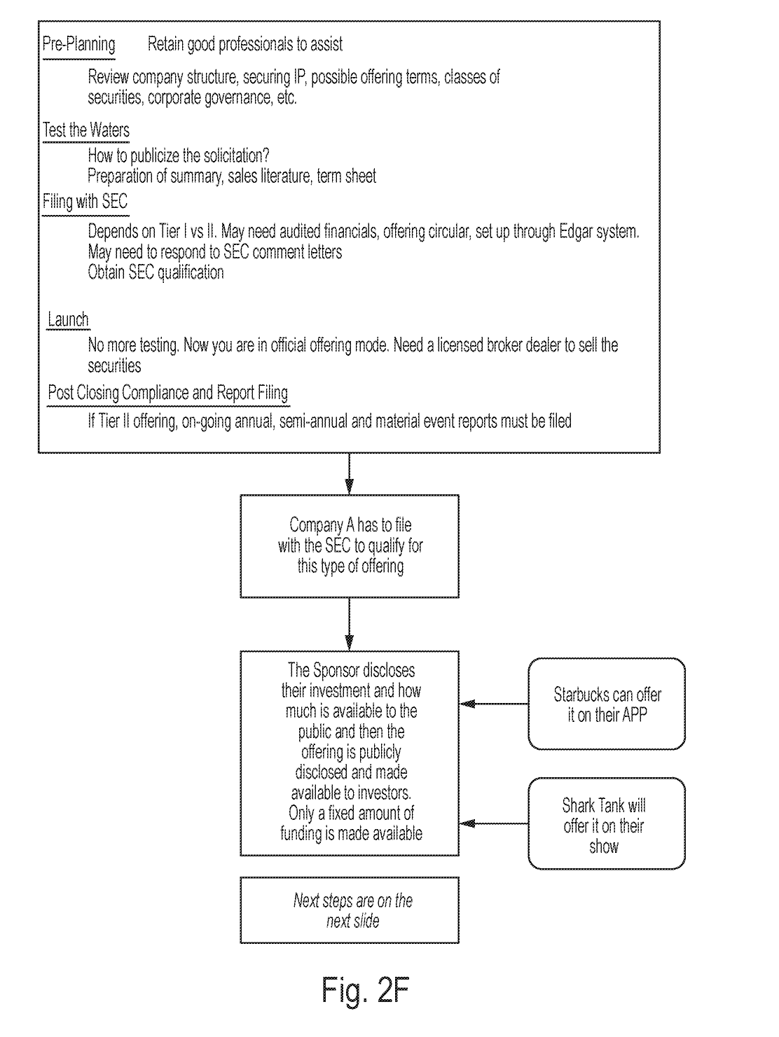

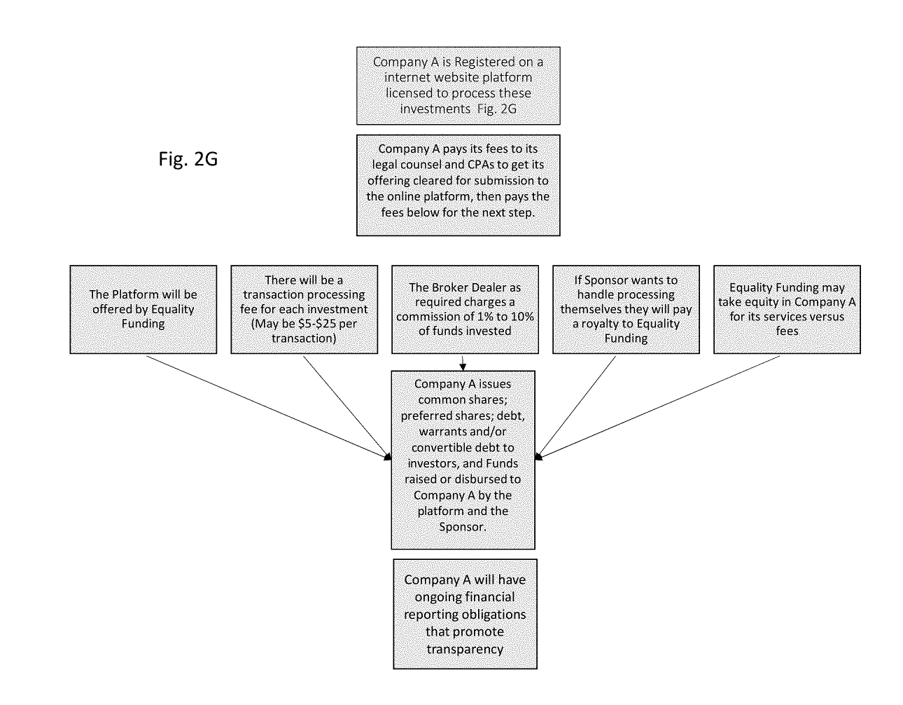

The platform 150 is programmed to with a method as described herein. Exemplary methods and systems 100 are illustrated in FIGS. 2A-2F in regards to flowcharts in which a plurality of user interface devices 120 are in communication with a platform 150.

Sponsor information 10 can be entered into the database 156 of the platform 150. The sponsor information 10 initially includes at least an identity of the sponsor 2, such as a logo or name. Sponsor information 10 can include the identity of the sponsor, biography, net worth, prior investments, and other information.

Investor information 12 can be entered into the database of the platform 150. The investor information 12 can include the name and contact information of potential investors 4 and registered investors 6. Potential investors 4 can be contacted 14 and requested to register as a registered investor 6 with the platform 150 by sending a text or other communication to the user interface devices 120 requesting them to log onto the platform 150 using the user interface device 120 and register as an investor utilizing the software 158. The potential investors 4 can register by logging onto 16 and inputting investor information 12 into the platform 150, downloading required compliance documents 18, completing the documents 18, and then uploading the compliance documents to the platform 150, or filling out the compliance documents 18 online. Thus, the investor information 12 can include the identity of investor, contact information, completed compliance documents, previous investments, investment knowledge, income, net worth, and other information.

Once the investor is registered 6, the user can log onto the platform 150 and display information 20 can be downloaded from the platform 150 to the user interface devices 120 to provide an investment display 22 on the user interface devices 120, utilizing the software 158.

Investment information 30 can be entered into the databased of the platform 150. Investment information 30 can include sponsor information 10 (identity of sponsor), an identity of a business entity 32 in need of capital, and an amount of sponsor investment 32 made by the sponsor to the business entity 8. The investment information 30 can also include an investment limit 34, the time the investment was made, and other information. The investment limit 34 can be a dollar amount, a time limit, a number of investors, any combination of these, and other limits. The investment information 30 can also include the compensation the investor 6 will receive for making the capital investment 38. The compensation can be ownership in the company, bonds, products made by the company, or any other desire compensation.

Investment information 30 can be transmitted 36 to a plurality of user interface devices 120 that are in communication with the platform 150. Investment information 30 is displayed on the display 22 of the user interface devices 120 so that registered investors 6 can view the investment information. If the investor 8 wants to participate and invest capital to the business entity 8, an investor capital investment 38 can be inputted into the user interface device 120 and then transmitted 40 from the user interface device 120 to the platform 150. Investor capital investments 38 transmitted 40 can be accepted by the platform 150 until the investment limit 34 is reached. When the investment limit 34 is reached no further investor capital investments 38 will be accepted by the platform 150.
The investor capital investments 38 when entered by the investor 6 into the user interface device 120 can first be considered as a bid 39. The bid 39 can be accepted or rejected by the platform 150 based on any desired parameters, for example by prioritizing investors, investment amount, time entered, or location entered. Bid 39 amounts can be preset or adjustable by the investor. Maximum and minimum bid 39 amounts can be set. Once the bid 39 is accepted by the platform it can be considered an investor capital investment 38. The bids 39 can be automatic based on an amount, sponsor, industry, or any other. The investors 6 can be prioritized for who receives an allocation to invest based on any desired parameter, such as first come first served, net worth, prior bidding, prior business relationships, length of relationship with sponsor, membership in an investor club, in possession of a special code, or any other. For example, if Starbucks is a sponsor we may agree with Starbucks that at least 50% of the funds accepted will come from Starbucks investors with a code issued by Starbucks. Alerts of upcoming deals can be sent to investors, with codes.

Alerts, which can be considered part of the sponsor investment information 20, can be sent to registered investors 6, and to prospective investors 2, about future offerings to participate in capital investments to business entities.

The sponsor 2 may have to file both with federal and state regulatory authorities including the Securities and Exchange Commission. This may have to be done prior to soliciting capital.

For media shows, such as Shark Tank, the presentation (business entity in need of capital) can be broadcast on a first show and then carried over to the next show to build excitement.

The investor information, such as prospective investors and registered investors, income, prior investments, etc., stored in the database provides significant value. In addition to raising capital, this investor information can be used to provide marketing information. Preferably, the investor information is retained on the database 156. However, certain sponsors may require that the investor information be retained on their personal database.

The platform 150 provides a software module 158, such as an app, that can be downloaded and stored on the user interface device 120.

Highlights of new rules that make equality funding possible will now be described. The Jobs Act which took over 4 years for the SEC to implement provides for general solicitation to both accredited and non-accredited investors, subject to a strict set of rules. This was not previously available. Set out below is a summary of the new rules:

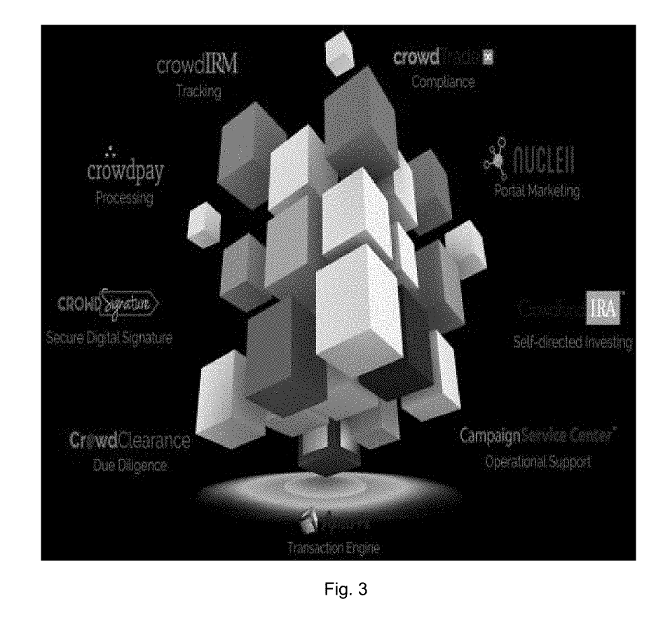

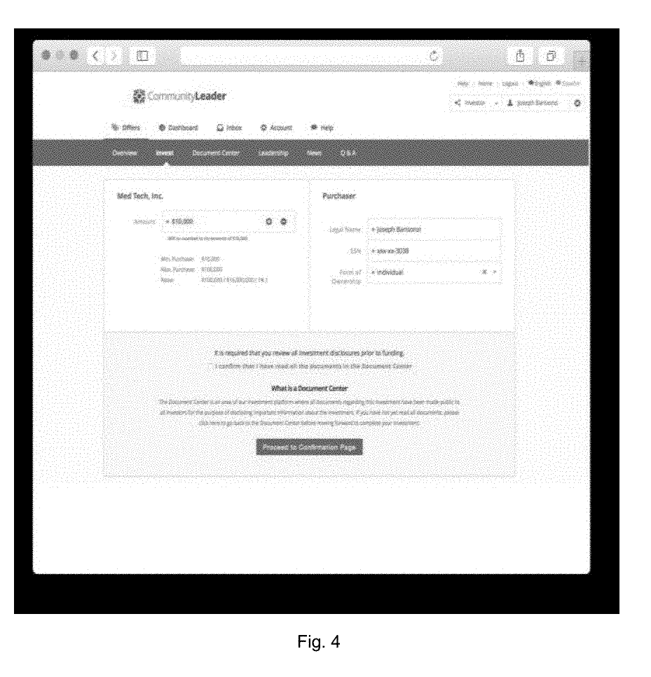

The present invention offers major companies, celebrities and medical outlets to use our compliant crowdfunding platform to effectuate their offering. For example, if Starbucks has a new deal it is pushed to its 12 million mobile users and placed on its website which both provide a link to our portal (website) which processes the investors orders. Set out in FIG. 3 is an example of how the process can work with an actual portal I will white label. FIG. 4 illustrates an exemplary investor screen.

An Integrated Suite of Applications and Services for a Complete, Customized and Compliant Investment Portal

For organizations that are seeking to build a crowdfunding Portal Platform for businesses in their “community” with a compliant and seamless eco-system of automated workflows, tools and services that protect the investors and support the business owner's efforts to raise the capital they need to grow.

Customized and Compliant. An Investment Operating System Built for a Unique Business Model.

CLi's Portal Platforms can be designed, developed and supported to match the investment Eco-system. The present invention is a fully integrated ecosystem that includes a robust compliant software solution with the essential best-of-class services. Designed as a flexible and robust private labeled enterprise solution, each deployment is configured to match a unique business.

The portals' business model can be configured based on:
Regulatory Environment
Target Market
Asset Class
Services Provided
Partner Network

FIG. 3 illustrates an exemplary portal.

Personalized Packages.

Flexible Software and Service Integration to Grow with the Business entity.

A service portal for connecting investors and offering in a non-transaction environment, for promoting offerings to investors, for service providers and associates to promote offerings, and provide added value service for current clients.

Examples of who can use a service portal include trades associations, business organizations, member organizations, regulated service providers and syndication exchanges.

Key features of the service portal code include compliant solicitation of private securities, investor accounts, source control on referrals, develop investor communities.

A proprietary portal for soliciting investors for assets and be owned or managed by the portal operator. For principals of offerings to solicit investor. For owner/operators to automate their capital raise process. Supports cost effective scaling of capital acquisition strategies.

Example of who can benefit from a proprietary service portal include real estate developers, asset-backed lenders, direct lenders, venture capital groups, and business incubators.

Key features of a proprietary service portal include the ability to leverage general solicitation rules, provide high touch investor services, automate investor acquisition workflow, and provide increased compliance opportunities.

A marketplace portal can be provided for connecting sponsored offerings with investors. For facilitating the sale of multiple third party offerings to investors, support complex workflow integration to match business models, and provide flexibility in use of multiple securities exemption models.

Examples of who the marketplace portal can be used for include broker-dealers, investment bankers, funding portals, crowdfunding portal operators, multi-operator investment sites, and business accelerators.

Key features of the marketplace portal include structured compliance workflows and reporting, full featured investor application, issuer due diligence and onboarding, network administrative functionality, and application integration server.

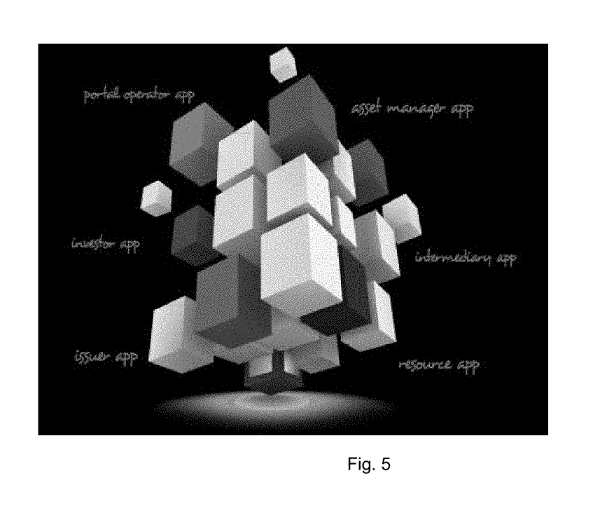

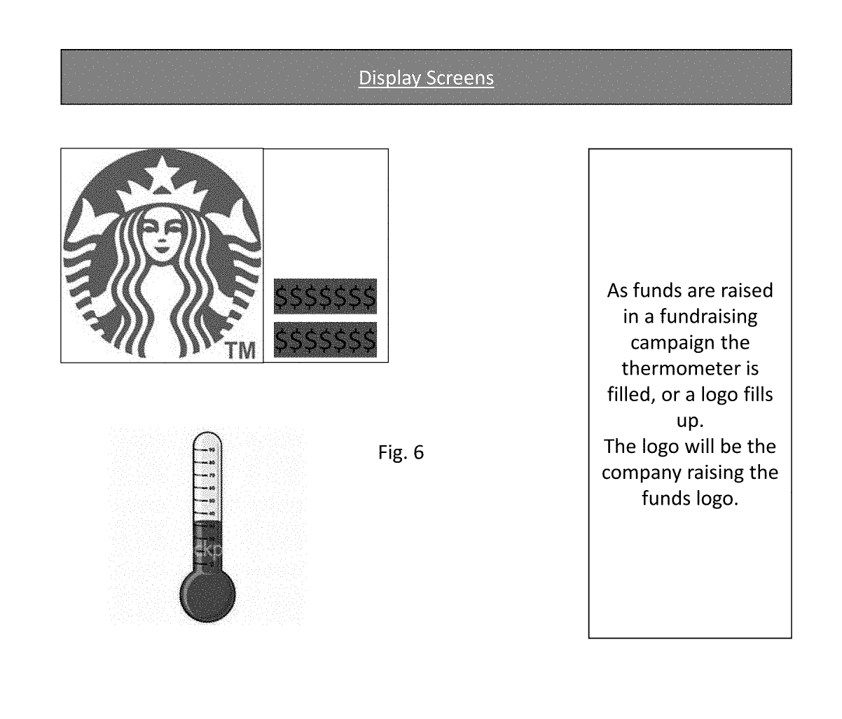

An Investment Operating System is shown in FIG. 5.

The most compliant, robust software package to support an investment ecosystem.

Integration & Customization

Create an EcoSystem That is unique to the business entity. The architecture of CLi's investment operating system is truly revolutionary and utilizes portal package design to be customized for individual design and workflow requirements.

What the system can do. From configurations of security exemption templates to custom design of offering pages, the CLi team has blended configuration, tiers of customization, and third party integration to ensure that no two deployments of the portal packages are the same.

Why It Can Do It. The Development Process.

Five Steps to Success.

Step 1: What Will It Do
Identify Business Proposition
Do a software demo
Review service packages
Develop a Term sheet
Execute on Term Sheet Agreement

Step 2: Establishing the Foundation
JumpStart project launch meeting
Project and Production Plan
License and Service Agreement
Legal Structural Model
Licensed Intermediary Engagement/Registration
Communications and Tracking Systems

Step 3: Launching the Portal
Logo and Style Guide
Initial Marketing Content
CrowdIRM Integration
Launch of Intial Beta Site
Launch initial investor/issuer acquisition efforts

Step 4: Launching the Platform
Deployment of standard package with Tier 1 customization
Load initial offerings
Platform Administrative Training
Marketing Launch
Official Launch
Transition to Campiagn Service Center support

Step 5: Making It Work
Ongoing Training and Support
Regular Consulting Meetings
Technical Fixes
Launch of Tier II and Tier III customization
Deployment of Integrated Projects

An example of a schedule 1 Reg A offering Timetable is as follows:

SCHEDULE 1
REG A OFFERING TIMETABLE
Multiple Steps: For Private to Public via REG A + Tier 2

| Step: | Date: | Narratives of Action Taken |
|---|---|---|
| Step 1 | | Company engagement Reg A+ consultant. (See |
| | | Attached Agreement) |
| Step 2 | 1 to | SEC attorney engaged and Company begins A/1 |
| | 30 | application |
| | days | Company engages PCAOB audit firm begins |
| | | audit. (at company's expense) |
| | | Develop shareholder list |
| Step 3: | 20 to 30 | Review Filing with SEC counsel |
| | days | 1. Business plan to convert to a Management |
| | | Discussion &Analysis with Financials to be |
| | | included in the filing with the SEC. |
| | | 2. Risk Factors |
| | | 3. Officers and directors questioners and |
| | | disclosure as supplied be SEC counsel |
| | | 4. List of 10% or more shareholders, affiliates and |
| | | control persons in accord with shareholder list |
| | | requirement of SEC transfer agent |
| | | 5. Confirm common share cap structure (recommend |
| | | cap structure not exceed 50 million shares) |
| | | 6. Complete audit of company |
| Step 4: | 30 to 60 | SEC counsel files Reg A+ A/1 with Securities and |
| | days | Exchange Commission via Edgar system |
| | | Register with Transfer Agent (2) |
| Step 5: | | All fees including the Reg A+ A/1 SEC attorney |
| | | filing, Edgar Agent Fees, Engagement of Transfer |
| | | agent are covered by the attached agreement. |
| | | Company must have funds available to complete |
| | | process from step 5 and beyond with |
| | | reserves depending on success of offering. |
| | Qualified | SEC may have comments or send a |
| | | qualified letter for of offering |
| | | Reg A+ A/1 “IPO” Ready for Public Sale |
| Step 6: | | Offering to investors, Dog and Pony show |
| | | Social Media Facebook and Twitter |
| | | Investor relations section Company website |
| | | FINRA application for Symbol (no fee) |
| | | DTC Application ($12,500 fee) |
| | | IMPORTANT FACTORS. |
| | | Legal must be in place for Filing with the SEC |
| | | Filings with the SEC must be made on time on the |
| | | EDGAR system with edger agent |
| | | Funds need to be available for all filings and |
| | | professionals for updated filings |
| | | Company must be provide information on a timely |
| | | manner to PCAOB firm |

This is only an estimated budget of possible fees: professional fee may differ depending on regulators questions and comments. Fees may also differ in the amount of shareholder participation in offering.

The inventions will be explained using the following non-limiting Examples.

### EXAMPLE 1

www.Starbucksangels.com

Starbucks has been fueling caffeine habits for years. Now, the coffee giant is having unusual success brewing a new kind of customer ritual. The company reported in 2016, on average, customers pay for a purchase using a smartphone 7 million times per week, with mobile payments now accounting for roughly 16 percent of total transactions. With so many payments coming from smartphones, it is clear that Starbucks has managed a feat that perhaps none of its brick-and-mortar store counterparts have: They've gotten shoppers accustomed to regularly engaging with them on a mobile device.

Even as mobile Web usage has surged, most retailers have so far struggled to get consumers to make purchases from their phones. During the holiday season, for example, record numbers of shoppers browsed on their phones, but very few actually used their phones to close the deal. Critical to the success of Starbucks's mobile payment platform is its integration with the My Starbucks Rewards program, which allows shoppers to earn special discounts and freebies. The loyalty program added nearly 900,000 new members in December 2016 alone, bringing its total membership to more than 12 million people as of April 2016. In a conference call with investors, chief executive Howard Schultz called the program one of Starbucks's most important business drivers, saying, “new members contribute not only short-term increases in revenue and profit, but also long-term loyalty for years to come.”

Starbucks has bigger ambitions for mobile shopping as customers are now able to place orders through their mobile app, a feature that the company believes will cut wait times at the counter.

Further evidence of the company's commitment to Web innovation came Thursday, when it announced that Kevin Johnson would become Starbucks president and chief operating officer. A veteran of Microsoft and Juniper Networks, the appointment appears squarely aimed at helping Starbucks transition into the digital era.

Some of the benefits to Starbucks's mobile transformation are obvious: It generates loyalty among its customers. But there are plenty of other possible payoffs. Starbucks is also gathering a rich trove of data about its most loyal customers, something it can eventually leverage to shape its marketing tactics, promotions and even store locations.

It should be noted that it's likely easier for Starbucks to cultivate a base of regular app users and large loyalty program membership, and that's because it's a business that is often deeply entwined with its customers' daily routine. This is what the press are saying about Starbucks and what it plans for the future. Set out below is one of Starbucks' recent investments and major push to make its digital platform important. This platform would serve as the launching off/distribution point for distribution of new investment opportunities that Starbucks wants to fund and get customer participation:

Starbucks Makes Investments
Starbucks to Invest $275M in Partners and Digital
By Jamie Grill-Goodman—Jan. 22, 2016

In quarter one, Starbucks delivered a 12% increase in revenue to a record $5.4 billion, despite the significant investments the company continues to make in its partners and its business. Starbucks expects investments in its partners and digital initiatives to total between $275 million and $300 million globally in 2016 compared to approximately $145 million in fiscal 2015.

Quarter one was also Starbucks' third sequential quarter of a 4% increase in global traffic. This holiday season, the company offered Holiday Spice Flat White and an expanded holiday food platform. It also leveraged its digital assets to reward loyal customers with five specialized Very Monday offers throughout the holiday season. Those offers, combined with the Starbucks for Life sweepstakes, open only to My Starbucks Rewards (MSR) members, drove customer traffic and increased MSR loyalty membership. The company increased the number of active MSR members in the U.S. to 11.1 million, up 23% over Q1 last year.

“You've got to ask yourself what's going to happen to the future of many of those malls that are anchored by those big-box retailers,” CEO Howard Schultz said, commenting on the recent news of Macy's and Walmart store closures. “Having said that, the investments that we made in our partner investments, which is store execution and retention of our people and the intimate relationship we have with the customer, coupled with the technology investments which have been significant, put up 4% traffic in this environment when there isn't a retailer in the country that is putting up anything close to 1% or 2%, let alone 9% comps in the quarter in the U.S. business, and we finished very strong for the quarter.”

The company said technology innovation is further strengthening its brand, improving its efficiency and in-store execution, increasing profitability and enabling the company to deliver an elevated Starbucks experience to its customers, particularly to Millennials.

“By anticipating and investing years ahead of the mobile technology curve, Starbucks today is redefining the customer-facing and partner-facing mobile and retail experiences of the future,” said Schultz.

One of those mobile experiences is the Starbucks mobile app. In the quarter, over 21% of total U.S. transactions were paid using the mobile apps and the company said it is seeing further acceleration in the month of January. Over 1 million customers in the U.S. used Starbucks' mobile order and pay capability in the month of December and those customers averaged approximately five mobile orders in the month.

“Usage of mobile order and pay is growing and we are now processing over 6 million mobile order and pay transactions per month,” said president and COO Kevin Johnson. “In many of our busiest stores where morning peak demand is high, mobile order and pay exceeds 10% of total transactions.”
According to Johnson, the company is expanding its digital agenda across four key pillars:
   1. Delivery: Starbucks is extending Mobile Order & Pay to include a delivery option for customers. Pilots are underway in Seattle and New York City.
   2. Personalized Offerings: The company has invested in technology to help better personalize the offers it makes to loyalty customers.
   3. Global Deployment: Starbucks is committed to leveraging these digital experiences in its major company-operated markets and with its licensee partners.
   4. Digital Media: The Spotify music capability Starbucks recently launched is one example of an integrated digital media experience. The company plans to explore additional digital media scenarios that are “entertaining and interesting” to consumers and that align with the Starbucks brand.

The present invention can be utilized as follows: Starbucks can be the sponsor 2 and the Starbucks' loyal customers as potential investors 4. Once the customers register, they can become registered investors 6. When Starbucks (sponsor 2) invests in a business entity 8, the investment information 30 can be transmitted to the user interface devices 120 of registered investors 6, and also the potential investors 4, so that the registered investors 6 can participate at the ground level funding of the business entity 8.

### EXAMPLE 2

TV Show Shark Tank could exploit the present invention by offering investors the ability to co-invest with the Sharks (sponsors) 2 once the sponsor 2 make a decision on a deal to fund a business entity 8. A ticker tape can run at the bottom of the TV screen showing the investment information 30, including how much is still available to invest with the sponsors 2. The investment information 30 can also be transmitted to the user interface devices 120 of the registered investors 6, and also the potential investors 4, so that the registered investors 6 can participate at the ground level funding of the business entity 8. The investment information 30 and bidding by investors 6 can be conducted on a different show from the show in which the sponsors 2 made a deal to fund a business entity 8. Upcoming deals to fund a business entity 8 can be considered alerts.

### EXAMPLE 3

Schedule 2: Testing The Waters Example

Company A Assessing Investor Interest, Looks to File Regulation A Plus Tier 2 to Raise Additional Working Capital.

Company A announced today that it has launched online a “Testing the Waters” campaign on the internet to gauge potential investor interest in the going public transaction. The Company A is measuring public support by targeting family, friends, customers, dealers, vendors and others as it seeks to raise up to $5MM of additional working and investment capital to support its growth strategies and surpass its operational goals.

Company A stated that its intention is to file a Regulation A Plus with the Securities and Exchange Commission (SEC) upon its “Testing the Waters” campaign reaching the threshold of $1 MM. The Company A disclosed that it plans to include the use of social media and email campaigns inviting interested parties to participate in the “Testing the Waters” campaign for the possible Regulation A Plus offering.

In the past only accredited investors, venture capitalists, and private equity firms have had the opportunity to invest via special securities in private to public transactions. This has changed as of June 2015 through the passing of the JOBS Act in April 2012 and the SEC's recent release of the regulations governing the new rules. In light of this change, the Company A is considering allowing existing customers, vendors, friends, and investors along with the general public to participate in the Company A Regulation A Plus Offering. The Regulation A Plus offering will be presented to investors in the order they participated in the “Testing the Waters” campaign. If you are interested in finding out more or participating in this going public transaction, you can indicate interest through the dedicated webpage,

Company A first qualifies the offering with Federal regulators, before investment into this Regulation A Plus deal can occur. Prior to doing so, Company A is “Testing the Waters” to gauge market demand from potential investors for an Offering under Tier II of Regulation A. No money or other consideration is being solicited, and if sent in response, it will not be accepted. Offers to buy securities cannot be accepted, and no part of the purchase price can be received, until an offering circular on Form 1-A is qualified. Any offer can be withdrawn or revoked at any time before notice of its acceptance is given after the qualification date of the offering circular. No sales of securities will be made or commitment to purchase accepted until qualification of the offering statement by the Securities and Exchange Commission and approval of any other required government or regulatory agency. An indication of interest made by a prospective investor is non-binding and involves no obligation or commitment of any kind. No offer of securities will be made without a qualified offering circular.

The Company A is working with a boutique consulting firm that specializes in Regulation A Plus. The company also reported that it has retained

The company's fully integrated mental health program includes the recruitment and training of licensed clinical social workers, licensed clinical psychologists, nurse practitioners and psychiatrists, all of whom have experience in meeting the unique needs of the geriatric community. The company meets with the skilled care facility to assess the specific mental health needs of the residents and then design and implement a customized clinical service program with ongoing management and administrative support services.

Forward-Looking & Safe Harbor Statement.

Certain statements in this news release may contain forward-looking information within the meaning of Rule 175 under the Securities Act of 1933 and Rule 3b-6 under the Securities Exchange Act of 1934, and those statements are subject to the safe harbor created by those rules. All statements, other than statements of fact, included in this release, including, without limitation, statements regarding potential plans and objectives of the Company, are forward-looking statements that involve risks and uncertainties. There can be no assurance that such statements will prove to be accurate and actual results and future events could differ materially from those anticipated in such statements. The Company cautions that these forward-looking statements are further qualified by other factors. The Company undertakes no obligation to publicly update or revise any statements in this release, whether as a result of new information, future events or otherwise.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of providing funding to a business entity comprising:
providing a platform connected to a network, the platform comprising a processor, non-transitory memory, a database stored in the memory, investor information stored in the database comprising name of investor, contact information of the investor, and whether the investor is a registered investor, sponsor information stored in the database comprising identification of sponsor, and the platform being programmed to connect to a plurality of user interface devices;
inputting investment information to a platform, the investment information comprising an identity of a business entity and a capital investment made from the sponsor to a business entity;
transmitting the investment information from the platform to the plurality of user interface devices, the user interface devices comprising a display;
displaying on the display a display screen comprising the investment information;
inputting, by registered investors, investor capital investments to the business entity on the plurality of user interface devices;
transmitting, by the user interface device, the investor capital investments to the server; and
accepting or denying, by the platform, the investor capital investments based on whether an investment limit has been reached.

2. The method according to claim 1, further comprising registering by a potential investor to become a registered investor.

3. The method according to claim 1, wherein the investment information comprises compensation registered investor will receive for the investor capital investment.

4. Network comprises internet and/or telephone and cable network further comprising providing the platform connected to the internet, and informing the plurality of investors where to connect to the platform via the internet).

5. The method according to claim 1, further comprising displaying on the display a running total of the number of investor capital investments.

6. The method according to claim 1, further comprising graphically displaying on the display a running total of the number of investor capital investments.

7. The method according to claim 1, further comprising displaying on the display a running total of the amount of investor capital investment.

8. The method according to claim 1, further comprising graphically displaying on the display a running total of the amount of investor capital investment.

9. The method according to claim 1, further comprising displaying on the display an amount of time left to enter the investor capital investment.

10. The method according to claim 1, further comprising graphically displaying on the display an amount of time left to enter the investor capital investment.

11. The method according to claim 1, further comprising displaying on the display an amount of available investor capital investment remaining to meet a limit on the total amount of investor capital investment.

12. The method according to claim 1, further comprising graphically displaying on the display an amount of available investor capital investment remaining to meet the investor capital investment limit on the total amount of investor capital investment.

13. The method according to claim 1, further comprising displaying on the display an amount of available number of investors remaining to meet the investment limit on a total number of investors.

14. The method according to claim 1, wherein the network comprises at least one of a wireless network, internet, a cable network, an optical fiber network, telephone network, and/or satellite network.

15. A system for providing capital to a business entity comprising:
a platform connected to the internet, the platform comprising software for performing the steps of claim 1 and a database of investor information;
a plurality of user interface devices connected to the platform via the internet, the user interface devices comprising a display.

16. A display screen for a user interface device having a display, the display screen comprising:
a name or logo identifying a business entity in need of capital;
a name or logo identifying a sponsor providing capital investment to the business entity;
a sponsor indicator statically identifying an amount of capital investment a sponsor transferred to the business entity;
a user graphical indicator dynamically identifying an investment limit for accepting a investor capital investment; and
an investor capital investment input.

17. The display screen according to claim 16, wherein the investment limit comprises at least one of a running total amount of investor capital investment, a running total number of investors, and/or an amount of time remaining to enter an investor capital investment.

18. The display screen according to claim 16, wherein investor graphical indicator dynamically identifies the running number of investor capital investments.

19. The display screen according to claim 16, wherein user graphical indicator dynamically identifies the running total amount of investor capital investment.

20. The display screen according to claim 16, wherein investor graphical indicator dynamically identifies the running amount of time.
